(19) United States
(12) Patent Application Publication
(10) Pub. No.: US 2021/0157478 A1
(43) Pub. Date: May 27, 2021

(54) TOUCH CONTROL APPARATUS AND METHOD

(71) Applicant: HUAWEI TECHNOLOGIES CO., LTD., Shenzhen (CN)

(72) Inventors: Fangrong JIANG, Shenzhen (CN); Chao ZAN, Dongguan (CN)

(21) Appl. No.: 17/164,872

(22) Filed: Feb. 2, 2021

Related U.S. Application Data
(63) Continuation of application No. PCT/CN2019/098060, filed on Jul. 27, 2019.

(30) Foreign Application Priority Data
Aug. 3, 2018 (CN) 201810876398.3

(51) Int. Cl. G06F 3/0488; G06F 3/0354; G06F 3/041; G06F 3/0484

(52) U.S. Cl. CPC G06F 3/04883; G06F 3/0484; G06F 3/0416; G06F 3/03545

(57) ABSTRACT

A touch control apparatus includes a touchscreen, a processor, and a pen slot configured to retain a stylus. A sensor disposed in the pen slot of the touch control apparatus detects that the stylus has been picked up, so that the processor is triggered to control the touchscreen to superimpose and display a writing interface on a current interface. Therefore, the stylus can perform a touch-control and/or a writing operation on the writing interface. This solves a problem that the touch-control and writing operation can be performed only when a button is first tapped to activate a dedicated writing program.

### CROSS-REFERENCE TO RELATED APPLICATIONS

This application is a continuation of International Application No. PCT/CN2019/098060, filed on Jul. 27, 2019, which claims priority to Chinese Patent Application No. 201810876398.3, filed on Aug. 3, 2018. The disclosures of the aforementioned applications are hereby incorporated by reference in their entireties.

### TECHNICAL FIELD

This application relates to the communications field, and in particular, to a touch control apparatus and method.

### BACKGROUND

With rapid development of the internet and communications technologies, office informatization has become an important part of an entire IT service system. An interactive touch-control display device (for example, an interactive electronic whiteboard) that is closest to a user is prevalent, and has become a standard accessory for a digital conference. To achieve better writing experience, an interactive touch control display device is usually equipped with a stylus S, helping the user write handwriting HW on a screen, as shown in FIG. 1.

However, when implementing a touch-control and writing function, an example existing interactive touch-control display device can only start a dedicated writing program and write in the writing program, and cannot implement the touch-control and writing function in an interface other than the writing program. For example, when a PPT slide is displayed, the user further wants to perform touch-control and writing operations such as writing comments or circling and modifying in a playing interface of the slide, but this cannot be implemented in an example prior art.

### SUMMARY

Embodiments of this application provide a touch control apparatus that can eliminate a prior-art limitation that a touch-control and writing operation can be performed only when a button is first tapped to activate a dedicated writing program.

According to a first non-limiting aspect of an example embodiment, a touch control apparatus is provided, including a touchscreen, a processor, and a pen slot configured to place a stylus, where a sensing component is disposed in the pen slot, and the sensing component is configured to: detect that the stylus placed in the pen slot is picked up, and generate a signal; the processor is configured to control, based on the signal generated by the sensing component, the touchscreen to superimpose and display a writing interface on a current interface; and the touchscreen is configured to display the writing interface on the current interface, and is further configured to: receive touch control of the stylus, and display, on the writing interface, a path generated by the touch control of the stylus.

That the stylus is picked up usually means that a user is about to write. The touch control apparatus in the non-limiting embodiments of this application can identify a user's intention, and display the writing interface on the current interface when the stylus is picked up, to implement an objective that the user can write when picking up the stylus.

With reference to implementations of the first aspect, in a first possible implementation of the first aspect, the writing interface has a background color or a transparent color.

With reference to the first aspect or the first possible implementation of the first aspect, in a second possible implementation, the writing interface has the background color when the touch control apparatus is in a standby state.

With reference to any one of the first aspect, or the first to the second possible implementations of the first aspect, in a third possible implementation, the writing interface has the transparent color when the touchscreen displays at least one of an interface corresponding to presentation data, an operation interface of an application program, and a system desktop.

When the writing interface has the background color, an interface before the writing interface is displayed may be blocked, to avoid an impact of previous interface content on handwriting. When the writing interface has the transparent color, an interface before the writing interface is displayed may be seen during writing, to facilitate presentation of the previous interface. For example, the interface before the writing interface is displayed is an office software interface.

With reference to any one of the first aspect, or the first to the third possible implementations of the first aspect, in a fourth possible implementation, the touchscreen is further configured to display a control button, and the processor is further configured to detect a position at which the stylus starts to touch the writing interface; and when the position is in a sensing area of the control button, the touchscreen is further configured to display an interface for performing an operation corresponding to the control button, or when the position is in an area other than the sensing area of the control button, the touchscreen is further configured to display a writing path generated by the touch control.

With reference to any one of the first aspect, or the first to the fourth possible implementations of the first aspect, in a fifth possible implementation, a magnet or a fastener is disposed in the pen slot, and the stylus is fastened to the pen slot by using the magnet or the fastener.

According to a second non-limiting aspect of an example embodiment, a touch control method is provided, including: detecting, by a touch control apparatus by using a sensing component disposed in a pen slot of the touch control apparatus, that a stylus placed in the pen slot is picked up, where the stylus is picked up to trigger the touch control apparatus to superimpose and display a writing interface on a current interface; superimposing and displaying, by the touch control apparatus by using a touchscreen of the touch control apparatus, the writing interface on the current interface; receiving, by the touch control apparatus by using the touchscreen, touch control of the stylus; and displaying, by the touch control apparatus on the writing interface, a path generated by the touch control. With reference to implementations of the second aspect, in a first possible implementation of the second aspect, the writing interface has a background color or a transparent color.

With reference to the second aspect, in a first possible implementation of the second aspect, the writing interface has the background color when the touch control apparatus is in a standby state.

With reference to the second aspect or with reference to the first possible implementation of the second aspect, in a second possible implementation, the writing interface has the transparent color when the touchscreen displays at least one of an interface corresponding to presentation data, an operation interface of an application program, and a system desktop.

With reference to any one of: the second aspect, the first to the second possible implementations of the second aspect, in a third possible implementation, the touch control apparatus further displays a control button on the touchscreen. The touch control apparatus also detects a position at which the stylus starts to touch the writing interface. When the position is in a sensing area of the control button, the touch control apparatus displays, on the touchscreen, an interface for performing an operation corresponding to the control button, or when the position is in an area other than the sensing area of the control button, the touch control apparatus displays, on the touchscreen, a writing path generated by the touch control.

With reference to any one of: the second aspect, the first to the third possible implementations of the second aspect, in a fourth possible implementation, the touch control apparatus fastens the stylus to the pen slot by using a magnet or a fastener disposed in the pen slot.

According to a non-limiting third aspect of an example embodiment, a computing device is provided, including a processor, a memory, a bus, and a communications interface, where the memory is configured to store a computing-device executable instruction, the processor is connected to the memory by using the bus, and when the computing device operates, the processor executes a computing-device executable instruction stored in the memory, so that the computing device performs the method according to any one of the second aspect or possible implementations of the second aspect.

According to a non-limiting fourth aspect of an example embodiment, a computer program product including an instruction is provided, where when the computer program product runs on a computer, the computer performs the method according to the second aspect.

According to the technical solutions provided in the embodiments of this application, the sensing component disposed in the pen slot of the touch control apparatus detects that the stylus is picked up, so that the processor is triggered to control the touchscreen to superimpose and display the writing interface on the current interface. Therefore, the stylus can perform the touch-control and writing operation on the writing interface, and this resolves a problem that the touch-control and writing operation can be performed only when a button is first tapped to activate the dedicated writing program.

### BRIEF DESCRIPTION OF DRAWINGS

To describe the technical solutions in the embodiments of this application more clearly, the following briefly describes the accompanying drawings of which.

FIG. 1 is a schematic diagram of writing on a screen by using a stylus in a prior art context;

FIG. 2 is a schematic structural diagram of a touch control apparatus according to an embodiment;

FIG. 3 is a schematic diagram of a stylus placed in a pen slot according to an embodiment;

FIG. 4 is a schematic structural diagram of a pen slot according to an embodiment;

FIG. 5 is a schematic diagram of a writing interface having a background color according to an embodiment;

FIG. 6 is a schematic diagram of a writing interface having a transparent color according to an embodiment;

FIG. 7 is a schematic diagram of displaying an interface for performing an operation corresponding to a control button according to an embodiment;

FIG. 8 is a schematic diagram of displaying a path generated by touch control of a stylus according to an embodiment;

FIG. 9 is a schematic structural diagram of a touch control apparatus according to an embodiment; and

FIG. 10 is an example of a flowchart of a touch control method 1000 according to an embodiment.

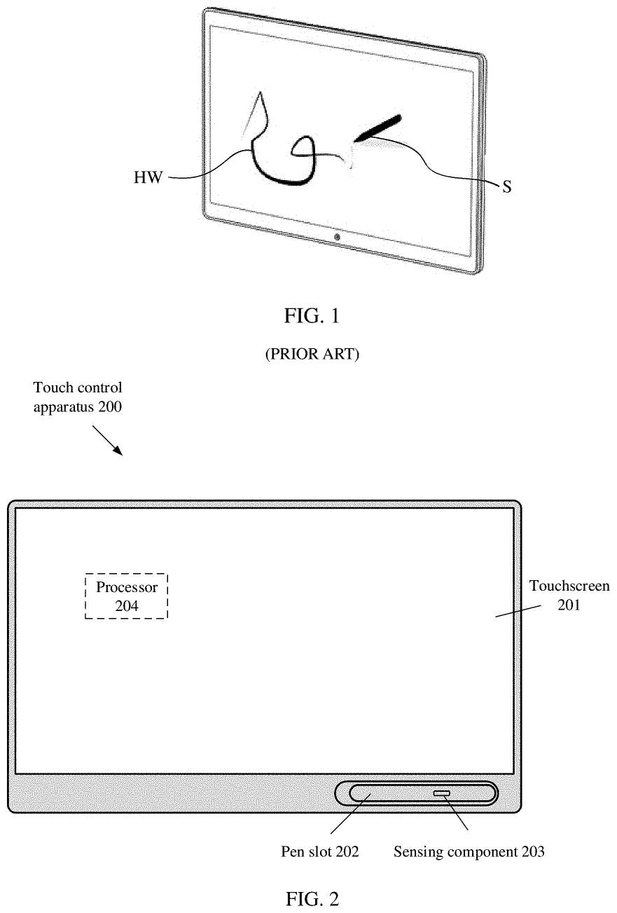

### DESCRIPTION OF NON-LIMITING EXAMPLE EMBODIMENTS

In the embodiments of this application, a touchscreen is also referred to as a touch panel, and is an induction liquid crystal display apparatus or a tablet display apparatus that can receive an input signal such as a contact (for example, a stylus or a finger). The stylus S is a pen-shaped tool, and is configured to input an instruction to a device having a touchscreen, such as a computer screen, a mobile device, or a drawingboard. A user may select a file or perform drawing by tapping the touchscreen by using the stylus S. Presentation data includes a to-be-displayed or to-be-operated file that is obtained by a conference terminal from an external device.

The following describes the embodiments with reference to the accompanying drawings.

FIG. 2 is a schematic structural diagram of a touch control apparatus 200 according to an embodiment. In FIG. 2, the touch control apparatus 200 includes a touchscreen 201 and a pen slot 202. The pen slot 202 is configured to place or hold a stylus S. The pen slot 202 is in a position and is configured for placing and retaining the stylus S, for example, a dent, depression, or the like, adapted to the stylus. A sensing component 203 is disposed in the pen slot 202. The sensing component 203 may be a sensor, such as a photoelectric sensor, and may be specifically an infrared light reflective sensor. The sensing component 203 may alternatively be an electromagnetic sensor or a touch switch. The touch control apparatus 200 further includes a processor 204. Because a processor is usually encapsulated inside a product and is invisible from outside, the processor 204 in the figure is represented by a dashed line. Although only one processor is shown in the figure, a person skilled in the art will understand that the touch control apparatus 200 may include a plurality of processors.

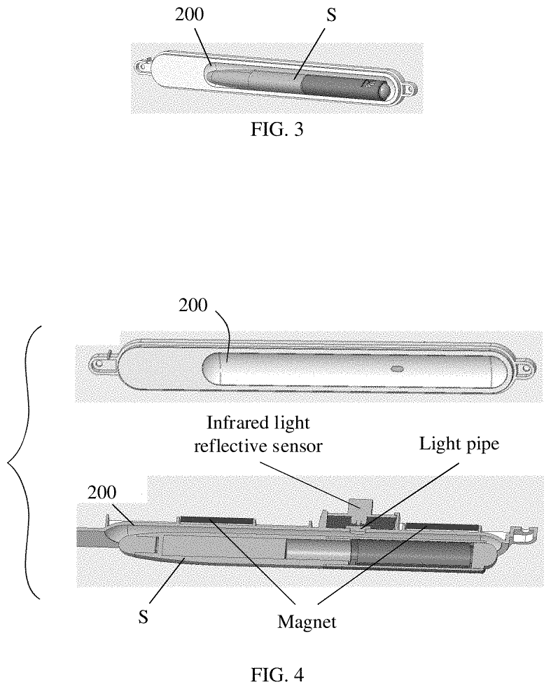

When the stylus S is not in use, the stylus is usually placed in the pen slot 202. A magnet or a fastener may be disposed in the pen slot 202, so that the stylus is retained in or fastened to the pen slot 202, as shown in FIG. 3. FIG. 4 is a schematic structural diagram of a pen slot according to an embodiment In FIG. 4, a magnet and an infrared light reflective sensor 203 are disposed in the pen slot 202, and a stylus S is attached to and retained within the pen slot by using the magnet.

The sensing component 203 is configured to detect whether the stylus S in the pen slot 202 is picked up, namely, whether the stylus leaves the pen slot 202. The sensing component 203 is further configured to generate a signal to trigger the processor 204 to control the touchscreen 201 to superimpose and display a writing interface on a current interface in response to the stylus S leaving the pen slot 202. For the photoelectric sensor 203, when the stylus S is picked up from the pen slot 202 or placed into the pen slot, light intensity received by the photoelectric sensor changes, so that whether the stylus is placed in the pen slot can be detected. The change in the light intensity causes a voltage change. The voltage change is quantized into a level signal of “0” or “1” (generally “0” is a low level, and “1” is a high level), and the signal triggers the processor 204 to control background software to start or not to start the writing interface. For the electromagnetic sensor, when the stylus S with a built-in magnet is picked up from the pen slot 202 or placed into the pen slot, magnetic field strength changes, so that whether the stylus is placed in the pen slot can be detected. The change in the magnetic field strength causes a voltage change. Similar to the photoelectric sensor, the voltage change triggers the processor 204 to control the background software to start or not to start the writing interface. For the touch switch, when the stylus S is picked up from the pen slot 202 or placed into the pen slot, the touch switch pops up or is pressed down, to detect whether the stylus is placed in the pen slot. The touch switch pops up or is pressed down to cause a voltage change. Similarly, the voltage change triggers the processor 204 to control the background software to start or not to start the writing interface. The processor 204 controlling the touchscreen 201 to superimpose and display a writing interface on a current interface includes superimposing a touch feature on the current interface. After the writing interface is superimposed and displayed, writing operations may be performed on the current interface by using the stylus S. The writing operations include operations such as writing and drawing.

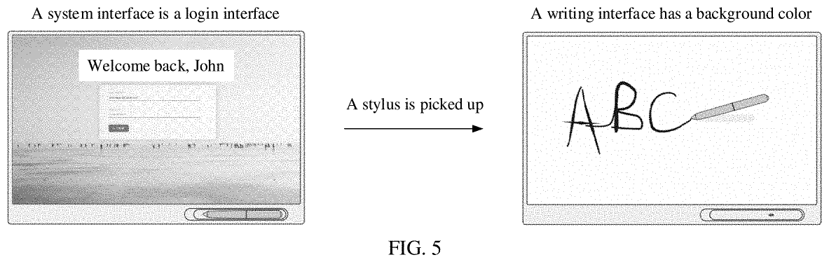

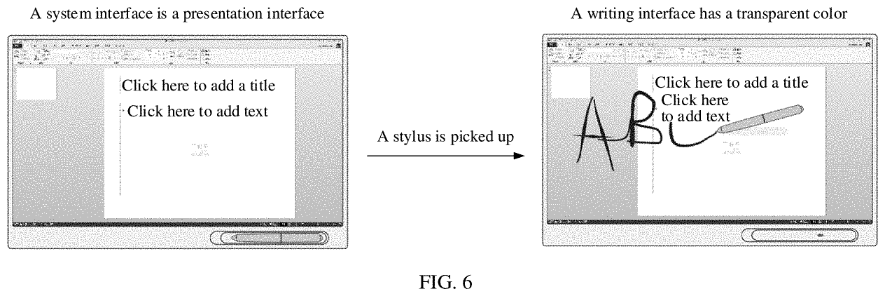

The processor 204 may control the touchscreen 201 to display a system interface such as a system desktop, an operation interface of an application program, and an interface (for example, a PPT slide) corresponding to presentation data in a conference. The processor 204 may further control the touchscreen to superimpose and display the writing interface on the currently displayed interface, and display, on the writing interface, a path generated by touch control of the stylus S. The writing interface may have a background color or a transparent color. When the writing interface has the background color, a system interface before the writing interface is displayed is blocked by the writing interface, as shown in FIG. 5. When the writing interface has the transparent color, a system interface before the writing interface is displayed may be seen through the writing interface, as shown in FIG. 6.

In an embodiment, when the touch control apparatus 200 is in a standby state, the writing interface has the background color; and when the touchscreen 201 displays at least one of the interface corresponding to the presentation data, the operation interface of the application program, or the system desktop, the writing interface has the transparent color.

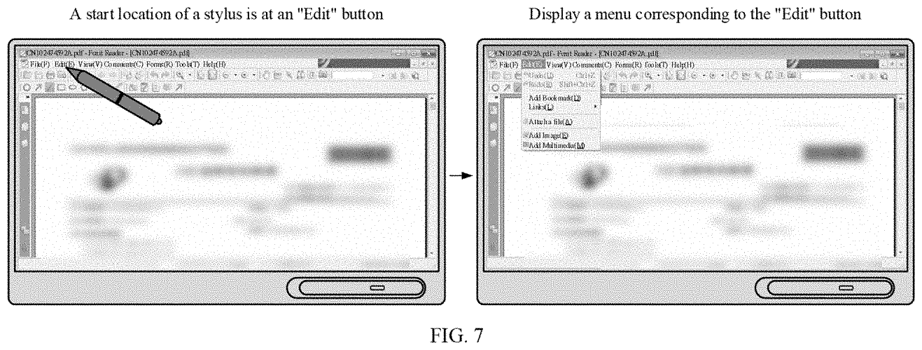

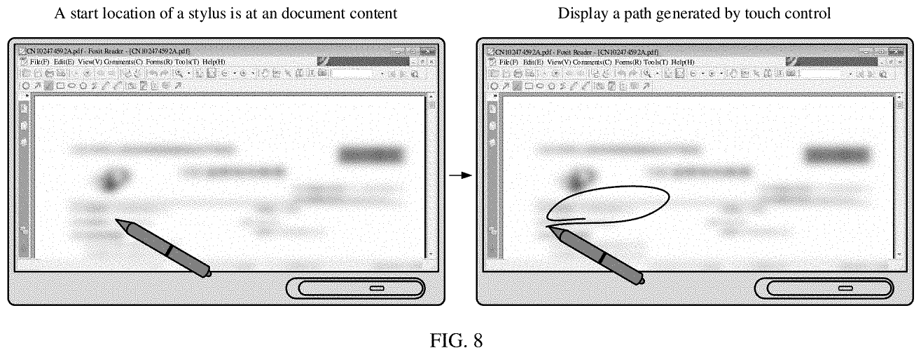

The touchscreen 201 is further configured to display a control button. An operation interface of an application program and a system desktop usually have a plurality of control buttons, for example, a “start” button and an “insert” button on a toolbar in office software such as Word, and an application icon on a desktop. Therefore, the processor 204 is further configured to detect a position at which the stylus S starts to touch the writing interface. When the touch position is in a sensing area of the control button, the processor 204 controls the touchscreen 201 to display an interface for performing an operation corresponding to the control button. This is because in this case, a user using the stylus S is more likely to want to tap the control button instead of writing. As shown in FIG. 7, an interface currently displayed on a touchscreen 201 is an office software interface, and buttons such as “File” and “Edit” are displayed on the interface. A position at which a stylus S starts to touch the touchscreen 201 is the “edit” button, and a user's intention is usually to tap the “edit” button. In this case, a processor 204 controls the touchscreen 201 to display an interface of a menu corresponding to the “edit” button. When the position is in an area other than the sensing area of the control button, the processor 204 controls the touchscreen 201 to display the path generated by the touch control of the stylus S. This is because in this case, a user using the stylus is more likely to want to write. As shown in FIG. 8, a position at which a stylus S starts to touch a touchscreen 201 is document content, and a user's intention is usually to write. In this case, a processor 204 controls the touchscreen 201 to display a path generated by touch control of the stylus S. The path generated by the touch control of the stylus S may also be referred to as handwriting HW.

According to the technical solutions provided in the embodiments of this application, the sensing component 203 disposed in the pen slot 202 of the touch control apparatus 200 detects that the stylus S is picked up, so that the processor 204 is triggered to control the touchscreen 201 to superimpose and display the writing interface on the current interface. Therefore, the stylus S can perform a touch-control and writing operation on the writing interface, and this resolves a problem that the touch-control and writing operation can be performed only when a button is first tapped to activate a dedicated writing program.

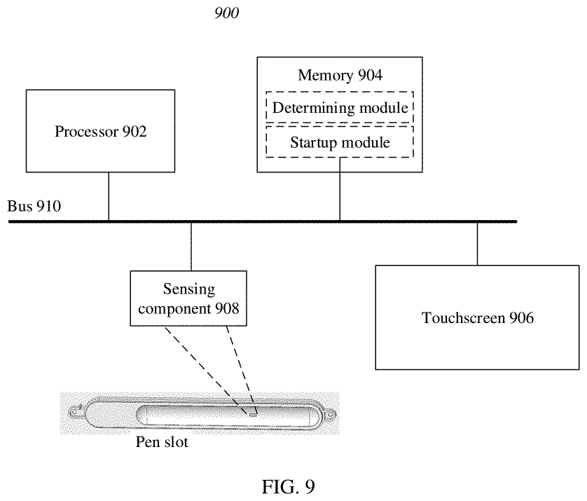

FIG. 9 is a schematic structural diagram of a touch control apparatus 900 according to an embodiment. As shown in FIG. 9, the touch control apparatus 900 includes a processor 902, a memory 904, a touchscreen 906, a sensing component 908, and a bus 910. Mutual communicative connections between the processor 902, the memory 904, the touchscreen 906, and the sensing component 908 are implemented by using the bus 910.

The processor 902 may be a general-purpose central processing unit (CPU), a microprocessor, an application-specific integrated circuit (ASIC), or one or more integrated circuits, and is configured to execute a related program stored in non-transitory memory (see below), to implement the technical solutions provided in the embodiments.

The memory 904 may be a read-only memory (ROM), a static storage device, a dynamic storage device, or a random access memory (Random Access Memory, RAM). The memory 904 may store an operating system and another application program. When the technical solutions provided in the embodiments of this application are implemented by using software or firmware, program code used for implementing the technical solutions provided in the embodiments of this application is stored in the memory 904, and is executed by the processor 902.

For descriptions of the touchscreen 906 and the sensing component 908, refer to the embodiments in FIG. 2 to FIG. 8. Details are not repeated.

The bus 910 may include a path for transmitting information between components (for example, the processor 902, the memory 904, the touchscreen 906, and the sensing component 908).

When the sensing component 908 detects that a stylus S is picked up or placed back in a pen slot 202, a generated signal is transmitted to the processor 902 by using the bus 910. The processor 902 executes the program code in the memory 904, to display or not display a writing interface on the touchscreen 906. In this embodiment, the program code in the memory 904 may include a determining module or routine and a startup module or routine. The determining module or routine is configured to determine whether the signal generated by the sensing component 908 is used to start the writing interface, and the startup module or routine is configured to start or not start to display the writing interface based on a determining result of the determining module or routine.

According to the technical solutions provided in this embodiment, the sensing component disposed in the pen slot 202 of the touch control apparatus 900 detects that the stylus S is picked up, so that the touchscreen 906 is triggered superimposing and displaying the writing interface on a current interface. Therefore, the stylus S can perform a touch-control and writing operation on the writing interface, and this resolves a problem that the touch-control and writing operation can be performed only when a button is first tapped to activate a dedicated writing program.

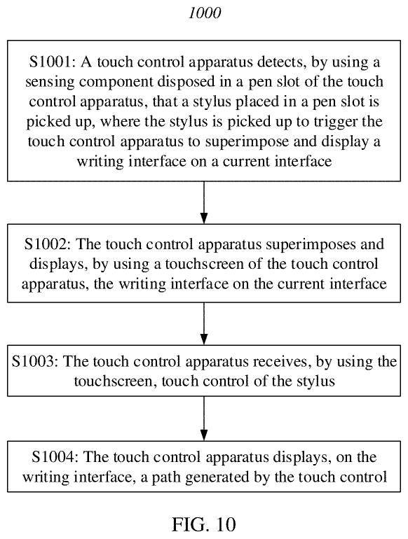

FIG. 10 is an example of a flowchart of a touch control method 1000 according to an embodiment. The touch control method 1000 is performed by a touch control apparatus. The touch control apparatus may be the touch control apparatus 200 in the embodiment in FIG. 2, or may be the touch control apparatus 900 in the embodiment in FIG. 9. The touch control apparatus may be specifically a device having a touch function, such as a mobile terminal, a tablet computer, or an electronic whiteboard.

S1001: The touch control apparatus detects, by using a sensing component 203, 906 disposed in a pen slot 202 of the touch control apparatus 200, 900, that a stylus S placed in the pen slot 202 is picked up, where the stylus is picked up to trigger the touch control apparatus to superimpose and display a writing interface on a current interface.

S1002: The touch control apparatus 200, 900 superimposes and displays, by using a touchscreen 201, 906 of the touch control apparatus, the writing interface on the current interface.

Before a user picks up the stylus S to write, the touchscreen 201. 906 of the touch control apparatus 200, 900 may be displaying a system interface (as described above) such as an operation interface of an application program, for example, an operation interface of office software Word. In this case, if the user wants to use the stylus S to write, the user picks up the stylus from the pen slot 202. When the stylus S is picked up, a sensor 201, 908 generates a signal, and the signal triggers background software to start the writing interface, where the writing interface is superimposed on the operation interface of the office software Word.

For descriptions of the sensing component 201, 908, refer to the embodiments in FIG. 2 to FIG. 6. Details are not repeated.

S1003: The touch control apparatus 200, 900 receives, by using the touchscreen 201, 906, touch control of the stylus S.

S1004: The touch control apparatus 200, 900 displays, on the writing interface, a path generated by the touch control.

The user writes on the touchscreen 201, 906 by using the stylus S, and the path generated by the touch control of the stylus is displayed on the writing interface.

For descriptions of the writing interface, refer to the embodiments in FIG. 2 to FIG. 6. Details are not repeated.

According to the technical solutions provided in this embodiment, the sensing component disposed in the pen slot of the touch control apparatus detects that the stylus is picked up, so that the touchscreen is triggered superimposing and displaying the writing interface on the current interface. Therefore, the stylus can perform a touch-control and writing operation on the writing interface, and this resolves a problem that the touch-control and writing operation can be performed only when a button is first tapped to activate a dedicated writing program.

The foregoing descriptions are merely non-limiting examples of specific implementations and are not intended to limit the protection scope, which is intended to cover, any variation or replacement readily determined by a person of ordinary skill in the art. Therefore, the claims shall define the protection scope.

What is claimed is:

1. A touch control apparatus, comprising:
a touchscreen,
a processor,
a pen slot configured to place or retain a stylus, and
a sensor disposed in the pen slot, and configured to: generate a signal in response to detecting that the stylus has been picked up;
wherein:
the processor is connected to receive the signal and is configured to control, based on the signal, the touchscreen to superimpose and display a writing interface on a current interface;
the touchscreen is configured to display the writing interface on the current interface; and
the touchscreen is further configured to: receive touch control of the stylus, and display, on the writing interface, a path generated by the touch control.

2. The apparatus according to claim 1, wherein the writing interface has a background color or a transparent color.

3. The apparatus according to claim 2, wherein the writing interface has the background color when the touch control apparatus is in a standby state.

4. The apparatus according to claim 2, wherein the writing interface has the transparent color when the touchscreen displays at least one of an interface corresponding to presentation data, an operation interface of an application program, and a system desktop.

5. The apparatus according to claim 4, wherein the touchscreen is further configured to display a control button, and the processor is further configured to detect a position at which the stylus starts to touch the writing interface; and
when the detected position is in a sensing area of the control button, the touchscreen is further configured to display an interface for performing an operation corresponding to the control button, or
when the detected position is in an area other than the sensing area of the control button, the touchscreen is further configured to display a writing path generated by the touch control.

6. The apparatus according to claim 1, wherein a magnet or a fastener is disposed in the pen slot, and the stylus is fastened to or retained within the pen slot by using the magnet or the fastener.

7. A touch control method, comprising:
superimposing, by a touch control apparatus, a writing interface on a current interface of the touch control apparatus based on a trigger signal;
superimposing and displaying, by the touch control apparatus by using a touchscreen of the touch control apparatus, the writing interface on the current interface;
receiving touch control by the touch control apparatus by using the touchscreen; and
displaying, by the touch control apparatus on the writing interface, a path generated by the touch control.

8. The method according to claim 8, further comprising:
detecting, by the touch control apparatus by using a sensor disposed in a pen holder of the touch control apparatus, that a stylus placed in the pen holder has been removed from the pen holder, wherein the detected removal of the stylus triggers the touch control apparatus to superimpose the writing interface on the current interface.

9. The method according to claim 7, wherein the writing interface has a background color or a transparent color.

10. The method according to claim 9, wherein the writing interface has the background color when the touch control apparatus is in a standby state.

11. The method according to claim 9, wherein the writing interface has the transparent color when the touchscreen displays at least one of an interface corresponding to presentation data, an operation interface of an application program, and a system desktop.

12. The method according to claim 11, wherein the touch control apparatus further displays a control button on the touchscreen; and the method further comprises:
detecting, by the touch control apparatus, a position at which a stylus starts to touch the writing interface; and
when the detected position is in a sensing area of the control button, displaying, by the touch control apparatus on the touchscreen, an interface for performing an operation corresponding to the control button, or
when the detected position is in an area other than the sensing area of the control button, displaying, by the touch control apparatus on the touchscreen, a writing path generated by the touch control.

13. The method according to claim 7, wherein the pen holder retains a stylus by using a magnet or a fastener disposed in the pen holder.

14. A touch control apparatus, comprising:
a touchscreen and
a processor operatively connected to the touch screen,
the processor being configured to control, based on a signal, the touchscreen to superimpose and display a writing interface on a current interface;
the touchscreen being configured to display the writing interface on the current interface; and
the touchscreen is further configured to: receive touch control, and display, on the writing interface, a path generated by the touch control.

15. The apparatus according to claim 14, wherein the touch control apparatus further comprises a pen holder configured to retain a stylus, the pen holder comprising
a sensor disposed in the pen holder, the sensor configured to: generate a signal upon detecting that the stylus placed in the pen holder has been picked up.

16. The apparatus according to claim 14, wherein the writing interface has a background color or a transparent color.

17. The apparatus according to claim 16, wherein the writing interface has the background color when the touch control apparatus is in a standby state.

18. The apparatus according to claim 16, wherein the writing interface has the transparent color when the touchscreen displays at least one of an interface corresponding to presentation data, an operation interface of an application program, and a system desktop.

19. The apparatus according to claim 18, wherein the touchscreen is further configured to display a control button, and the processor is further configured to detect a position at which a stylus starts to touch the writing interface; and
when the detected position is in a sensing area of the control button, the touchscreen is further configured to display an interface for performing an operation corresponding to the control button, or
when the detected position is in an area other than the sensing area of the control button, the touchscreen is further configured to display a writing path generated by the touch control.

20. The apparatus according to claim 14, further comprising a magnet or a fastener disposed in a pen slot, the magnet or fastener retaining or fastening a stylus to the pen slot.
